(19) United States
(12) Patent Application Publication
(10) Pub. No.: US 2023/0085276 A1
(43) Pub. Date: Mar. 16, 2023

(54) Environmental Data Monitoring And Feedback Controlling System And Method Thereof

(71) Applicants: Inventec (Pudong) Technology Corporation, Shanghai (CN); Inventec Corporation, Taipei City (TW)

(72) Inventor: Zhe-Zhang Yuan, Shanghai (CN)

(21) Appl. No.: 17/479,552

(22) Filed: Sep. 20, 2021

(30) Foreign Application Priority Data
Sep. 14, 2021 (CN) 202111072812.3

(51) Int. Cl. F24F 11/63; H04W 4/38; G05B 19/05; F24F 11/58; F24F 11/523; F24F 11/526

(52) U.S. Cl. CPC F24F 11/63; F24F 11/58; F24F 11/523; F24F 11/526; G05B 19/05; H04W 4/38; H04L 51/04

(57) ABSTRACT

An environmental data monitoring and feedback controlling system and a method thereof are disclosed, a first wireless transceiver module is electrically connected to environmental sensors to form a sensor module, a server is electrically connected to a second wireless transceiver module to form a network gateway, and the server polls the sensor module to receive and store the environmental data through the network gateway, and permits a display panel device to load and display the stored environmental data in a chart. When the environmental data exceeds a preset threshold, a warning device is driven to write the received environmental data into a register of a programmable logic controller of an air conditioning device, so that the control logic automatically controls the air conditioning device to activate or stop based on the environmental data stored in the register, thereby improving the correction immediacy for environmental abnormality.

### BACKGROUND OF THE INVENTION

### 1. Field of the Invention

The present invention relates to a monitoring and controlling system and a method thereof, more particularly to an environmental data monitoring and feedback controlling system and a method thereof.

### 2. Description of the Related Art

In recent years, with the popularization and vigorous development of automated production, many production environments have strict requirements on environmental factors such as temperature, humidity, and dust. If environmental abnormalities occur, the risk of automated production will increase significantly. Therefore, how to immediately correct environmental abnormalities has become one of the problems that manufacturers urgently want to solve.

Generally speaking, different environmental factors will cause different problems, for example, excessively low humidity may easily generate static electricity and cause damage to electronic products; excessively high temperature may easily cause the electronic equipment in operation to crash and affect production. A server assembly test area is taken as an example for description, before assembled servers are shipped, they need to be tested to ensure that the products to be shipped are products with good performance. When a large number of servers are clustered together to run tests, a large amount of power consumption will generate a large amount of heat, and it causes the continuously increase of environmental temperature. Therefore, the production environment needs to be equipped with powerful air-conditioning equipment to control the environmental temperature by using fans to blow cold air, to ensure that the equipment runs within the appropriate temperature range. In addition, because temperature changes affect humidity changes, it is also necessary to improve the environment by air-conditioning equipment. However, the production environment is usually equipped with a low amount of temperature and humidity meters or a large temperature and humidity meter for environmental monitoring, and the temperature and humidity meters with insufficient amount and the low distribution density are unable to reflect the real environmental status in real time, so it is impossible to perform appropriate countermeasure in response to the change in the environmental status in real time. Therefore, there is a problem of insufficient immediacy of correcting environmental abnormalities in the existing production environment.

According to the above-mentioned contents, what is needed is to develop an improved technical solution to solve the conventional technology problem of insufficient correction immediacy for environmental abnormality.

### SUMMARY OF THE INVENTION

An objective of the present invention is to provide an environmental data monitoring and feedback controlling system and a method thereof, so as to solve the above-mentioned conventional technology problem.

In order to achieve the objective, the present invention discloses an environmental data monitoring and feedback controlling system, and the system includes a plurality of environmental sensors, a first wireless transceiver module, a second wireless transceiver module, an air conditioning device and a server. The plurality of environmental sensors are configured to continuously sense environmental data. The first wireless transceiver module is electrically connected to the plurality of environmental sensors, to form a sensor module, and configured to transmit the environmental data. The second wireless transceiver module is configured to execute a wireless network transmission protocol the same as that of the first wireless transceiver module, to form a wireless network. The air conditioning device includes a programmable logic controller which comprises at least one register and is interconnected to a network. The server is electrically connected to the network and the second wireless transceiver module to form a network gateway, and includes a polling module, a storage module, and a control module. The polling module is configured to poll the sensor module to receive the environmental data through the network gateway in a wireless network. The storage module is connected to the polling module and configured to store the received environmental data to a database, permit a display panel device to load the environmental data from the database to display the loaded environmental data. The control module is connected to the storage module, and configured to generate a driving signal to drive a warning device, and write the environmental data into the at least one register of the programmable logic controller of the air conditioning device when the control module detects that the environmental data exceeds a preset threshold.

In order to achieve the objective, the present invention discloses an environmental data monitoring and feedback controlling method, and the method includes the following steps of: providing a first wireless transceiver module which is electrically connected to a plurality of environmental sensors to form a sensor module, providing a server which is electrically connected to a network and a second wireless transceiver module to form a network gateway, wherein the first wireless transceiver module and the second wireless transceiver module execute the same wireless network transmission protocol to form a wireless network; using the server to poll the sensor module to receive environmental data through the network gateway in the wireless network, and storing the environmental data to a database, permitting a display panel device to load the environmental data from the database, and displaying the loaded environmental data on the display panel device; when the server detects that the environmental data exceeds a preset threshold, generating a driving signal to drive a warning device, and writing the received environmental data into the at least one register of the programmable logic controller of the air conditioning device, wherein the programmable logic controller is interconnected to the server through the network; using the air conditioning device to drive the relay based on a control logic of the programmable logic controller and the environmental parameter of the register, so as to control the air conditioning device to activate or stop.

According to the above-mentioned system and method of the present invention, the difference between the conventional technology and the present invention is that, in the present invention, the first wireless transceiver module is electrically connected to environmental sensors to form the sensor module, the server is electrically connected to the second wireless transceiver module to form the network gateway, and the server polls the sensor module to receive and store the environmental data through the network gateway, and permits the display panel device to load and display the stored environmental data in the chart; when the environmental data exceeds the preset threshold, the warning device is driven to write the received environmental data into the register of the programmable logic controller of an air conditioning device, so that the control logic can automatically control the air conditioning device to activate or stop based on the environmental data stored in the register.

Therefore, the technical solution of the present invention is able to achieve the technical effect of improving the correction immediacy for environmental abnormality.

### BRIEF DESCRIPTION OF THE DRAWINGS

The structure, operating principle and effects of the present invention will be described in detail by way of various embodiments which are illustrated in the accompanying drawings.

FIG. 1 is a system block diagram of an environmental data monitoring and feedback controlling system of the present invention.

FIG. 2 is a flowchart of an environmental data monitoring and feedback controlling method of the present invention.

FIG. 3 is a schematic diagram of an operation to monitor environmental data and control feedback, according to the application of the present invention.

FIG. 4 is a schematic diagram of displaying charts on a display panel device, according to the application of the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims.

These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts. As used herein, the singular forms “a”, “an” and “the” are intended to include the plural forms as well, unless the context clearly indicates otherwise.

It is to be acknowledged that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the words “comprise” and “include”, and variations such as “comprises”, “comprising”, “includes”, or “including”, will be acknowledged to imply the inclusion of stated elements but not the exclusion of any other elements.

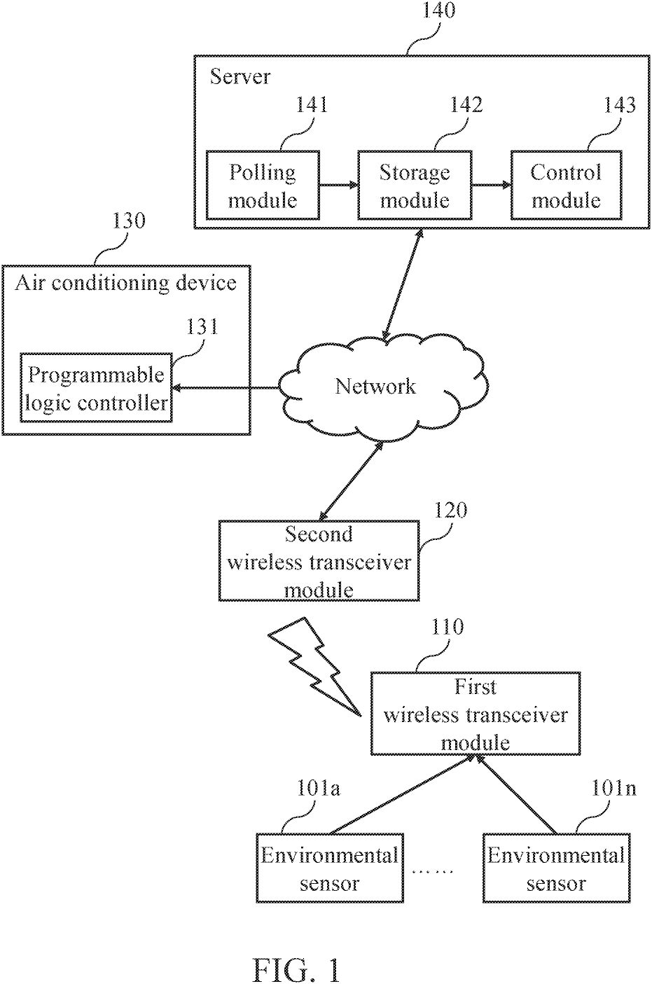

Please refer to FIG. 1, which is a system block diagram of an environmental data monitoring and feedback controlling system of the present invention. As shown in FIG. 1, the environmental data monitoring and feedback controlling system includes environmental sensors 101a~101n, a first wireless transceiver module 110, a second wireless transceiver module 120, and an air conditioning device 130, and a server 140. The environmental sensors 101a∼101n are used to continuously sense environmental data. In actual implementation, the environmental sensors 101a~101n include sensors for sensing at least one of temperature and humidity, the environmental data include at least one of data of temperature and humidity.

The first wireless transceiver module 110 is electrically connected to the environmental sensors 101a~101n to form a sensor module, and configured to transmit the environmental data. In actual implementation, the first wireless transceiver module 110 can apply the transmission technology of low-power wide-area network (LPWAN), such as LoRa, Weightless, RPMA, HaLow or NB-IoT.

The second wireless transceiver module 120 and the first wireless transceiver module 110 execute the same wireless network transmission protocol, to form a wireless network. In other words, the first wireless transceiver module 110 and the second wireless transceiver module 120 are the same devices, and the difference between the first wireless transceiver module 110 and the second wireless transceiver module 120 is that the first wireless transceiver module 110 is connected to the environmental sensors, and the second wireless transceiver module 120 is connected to the Ethernet; for example, the first wireless transceiver module 110 and the second wireless transceiver module 120 can be LoRa serial servers USR-LG206-L-P executing LoRa wireless network transmission protocol to form an LoRa wireless network, the first wireless transceiver module 110 is connected to the environmental sensor through RS485, and the second wireless transceiver module 120 is connected to an adapter UT6601H for converting RS485 to RJ45, through RS485, so as to connect Ethernet with RJ45. In this way, the environmental data can be transmitted to the server 140 through the LoRa wireless network and the Ethernet, in sequential order.

The air conditioning device 130 includes a programmable logic controller 131 which includes a register and is interconnected to the network. In actual implementation, each of the environmental data and the air conditioning device 130 can include an area identifier, and when the area identifier of the air conditioning device 130 matches with the area identifier of the environmental data, the relay is driven to control the air conditioning device 130 to activate or stop; in other words, the area identifier can be used to determine whether the area where the environmental data is generated matches with the location of the air conditioning device, that is, the same area identifiers indicates the locations matched with each other, and different area identifiers indicate the locations not matched with each other. Furthermore, the transmission in the network can be performed by a wired transmission manner or a wireless transmission manner; for example, the transmission medium of the wired transmission manner can be conductive copper line, coaxial cable, fiber, dual twisted wire or the like, and the transmission medium of the wireless transmission manner can be radio wave, microwave, infrared, laser or the like.

The server 140 is electrically connected to the network and the second wireless transceiver module 120 to form a network gateway, the server 140 includes a polling module 141, a storage module 142, and a control module 143. The polling module 141 can poll the sensor module to receive the environmental data through the network gateway in the wireless network. In actual implementation, the number of the sensor module formed by the first wireless transceiver module 110 and the environmental sensors 101a~101n can be more than one, and the sensor module and the second wireless transceiver module 120 can form the wireless network to transmit the environmental data.

The storage module 142 is connected to the polling module 141, and configured to store the received environmental data to a database, permit a display panel device to load the environmental data from the database and display the loaded environmental data. In actual implementation, after the display panel device loads the environmental data, the display panel device can execute a visualization analysis on the loaded environmental data to generate and display a chart containing data variation; for example, the chart can be a line chart, a pie chart, a radar chart, or a bar chart. Furthermore, the database can be a relational database, NoSQL, or the like.

The control module 143 is connected to the storage module 142. When control module 143 detects that the environmental data exceeds the preset threshold, the control module 143 generates a driving signal to drive a warning device, and writes the received environmental data into the register of the programmable logic controller 131 of the air conditioning device 130. In actual implementation, the control module 143 can be implemented by a micro control unit (MCU), a microprocessor, a central processing unit (CPU) or a system on a chip (SoC), to execute computer commands, such as comparing commands or writing commands. It should be particularly noted that the warning device can include at least one of a warning lamp, a speaker and a display, and when the driving signal is generated, an administrator can be notified by at least one of email and instant messaging in the form of at least one of text, image and voice.

It should be particularly noted that, in actual implementation, the modules of the present invention can be implemented by various manners, including software, hardware or any combination thereof, for example, in an embodiment, the module can be implemented by software and hardware, or one of software and hardware. Furthermore, the present invention can be implemented fully or partly based on hardware, for example, one or more module of the system can be implemented by integrated circuit chip, system on chip (SOC), a complex programmable logic device (CPLD), or a field programmable gate array (FPGA). The concept of the present invention can be implemented by a system, a method and/or a computer program. The computer program can include computer-readable storage medium which records computer readable program instructions, and the processor can execute the computer readable program instructions to implement concepts of the present invention. The computer-readable storage medium can be a tangible apparatus for holding and storing the instructions executable of an instruction executing apparatus Computer-readable storage medium can be, but not limited to electronic storage apparatus, magnetic storage apparatus, optical storage apparatus, electromagnetic storage apparatus, semiconductor storage apparatus, or any appropriate combination thereof. More particularly, the computer-readable storage medium can include a hard disk, an RAM memory, a read-only-memory, a flash memory, an optical disk, a floppy disc or any appropriate combination thereof, but this exemplary list is not an exhaustive list. The computer-readable storage medium is not interpreted as the instantaneous signal such a radio wave or other freely propagating electromagnetic wave, or electromagnetic wave propagated through waveguide, or other transmission medium (such as optical signal transmitted through fiber cable), or electric signal transmitted through electric wire. Furthermore, the computer readable program instruction can be downloaded from the computer-readable storage medium to each calculating/processing apparatus, or downloaded through network, such as internet network, local area network, wide area network and/or wireless network, to external computer equipment or external storage apparatus. The network includes copper transmission cable, fiber transmission, wireless transmission, router, firewall, switch, hub and/or gateway. The network card or network interface of each calculating/processing apparatus can receive the computer readable program instructions from network, and forward the computer readable program instruction to store in computer-readable storage medium of each calculating/processing apparatus. The computer program instructions for executing the operation of the present invention can include source code or object code programmed by assembly language instructions, instruction-set-structure instructions, machine instructions, machine-related instructions, micro instructions, firmware instructions or any combination of one or more programming language. The programming language include object oriented programming language, such as Common Lisp, Python, C++, Objective-C, Smalltalk, Delphi, Java, Swift, C#, Perl, Ruby, and PHP, or regular procedural programming language such as C language or similar programming language. The computer readable program instruction can be fully or partially executed in a computer, or executed as independent software, or partially executed in the client-end computer and partially executed in a remote computer, or fully executed in a remote computer or a server.

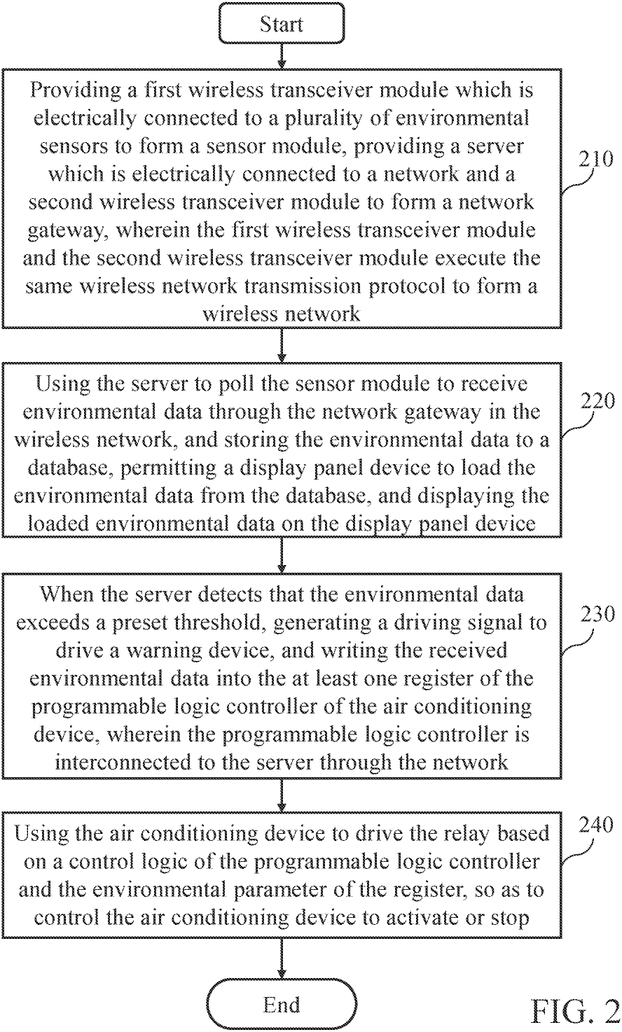

Please refer to FIG. 2, which is a flowchart of an environmental data monitoring and feedback controlling method of the present invention. As shown in FIG. 2, the method includes steps 210 to 240. In the step 210, a first wireless transceiver module 110, which is electrically connected to a plurality of environmental sensors 101a~101n to form a sensor module, is provided, and a server 140, which is electrically connected to a network and a second wireless transceiver module to form a network gateway, is provided, and the first wireless transceiver module 110 and the second wireless transceiver module 120 execute the same wireless network transmission protocol to form a wireless network. In the step 220, the server 140 polls the sensor module to receive environmental data through the network gateway in the wireless network, and store the environmental data to a database, and permit a display panel device to load the environmental data from the database, and the loaded environmental data is displayed on the display panel device. In the step 230, when the server 140 detects that the environmental data exceeds a preset threshold, the server 140 generates a driving signal to drive a warning device, and writes the received environmental data into the at least one register of the programmable logic controller 131 of the air conditioning device 13, and the programmable logic controller 131 is interconnected to the server 140 through the network. In the step 240, the air conditioning device 130 drives a relay based on a control logic of the programmable logic controller and the environmental parameter of the register, so as to control the air conditioning device 130 to activate or stop. Therefore, the environmental sensors 101a~101n are electrically connected to the first wireless transceiver module 110 form the sensor module, the server 140 is electrically connected to the second wireless transceiver module 120 to form the network gateway, the server 140 polls the sensor module to receive and store the environmental data through the network gateway, and permit the display panel device to load and display the stored environmental data in a chart, and when the environmental data exceeds the preset threshold, the warning device is driven to write the received environmental data into the register of the programmable logic controller 131 of the air conditioning device 130, so that the control logic can automatically control the air conditioning device 130 to activate or stop based on the environmental data stored in the register.

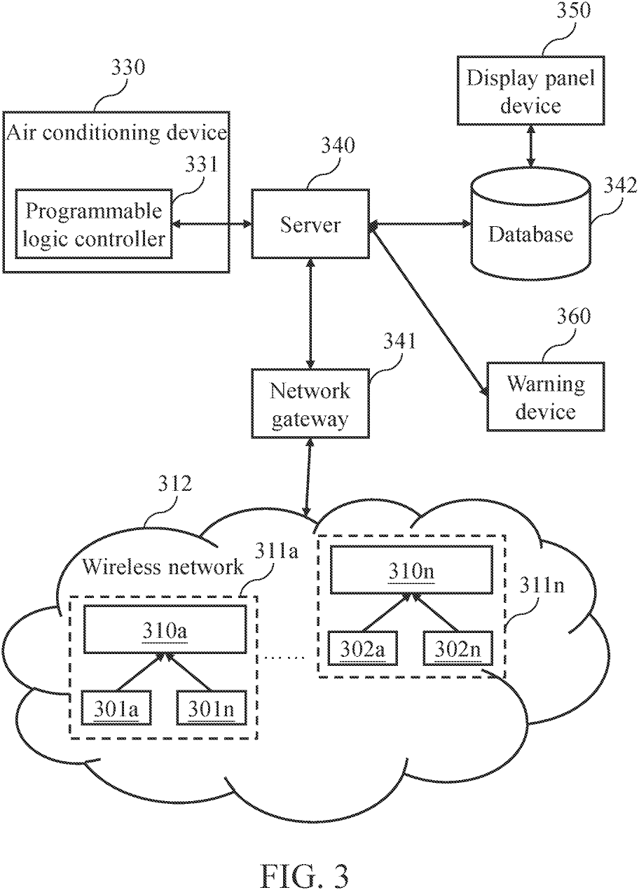

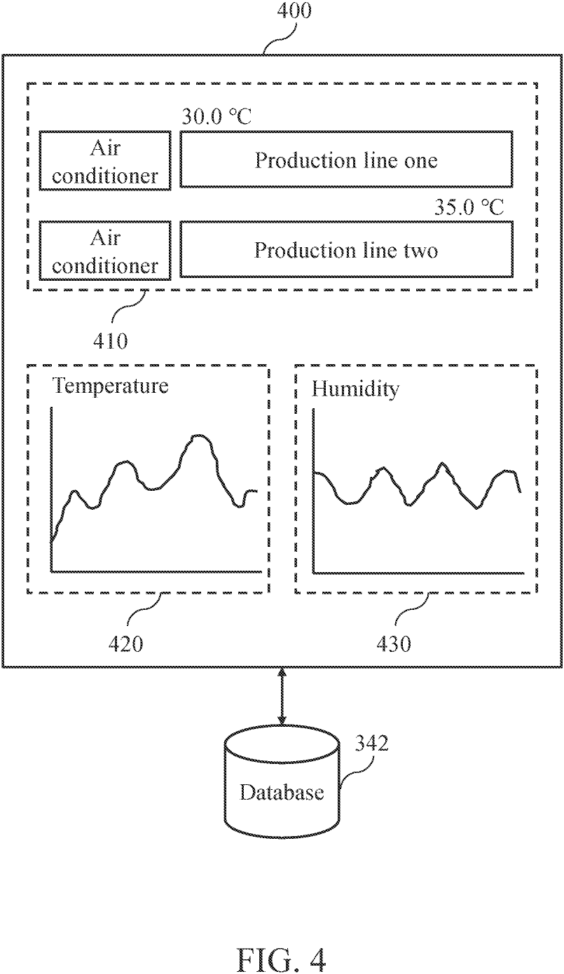

The embodiment of the present invention will be described in the following paragraphs with reference to FIG. 3 and FIG. 4. Please refer to FIG. 3, which is a schematic diagram of an operation to monitor environmental data and control feedback, according to the application of the present invention. When the present invention is applied in a production place to monitor the environmental data and control feedback, the first wireless transceiver modules 310a~310n can be disposed in different areas of the production place, respectively; the first wireless transceiver module 310a is electrically connected to environmental sensors 301a~301n to form a sensor module 311a, the first wireless transceiver module 310n is electrically connected to environmental sensors 302a~302n to form a sensor module 311n. Furthermore, the server 340 is also interconnected to the environmental sensor 301a~301n through the network gateway 341, the second wireless transceiver module of the network gateway 341 and the first wireless transceiver modules 310a~310n execute the same wireless network transmission protocols, such as LoRa protocol. The server 340, the database 342, the display panel device 350, the warning device 360 and the programmable logic controller 331 of the air conditioning device 330 can be interconnected to each other through the Ethernet. It should be particularly noted that the database 342 can be disposed inside the server 340 or in the outsides of the server 340.

In order to monitor the environmental data, the server 340 polls the sensor modules 311a~311n to receive the environmental data through the network gateway 341 in the wireless network 312, and stores the environmental data to a database 342, and permits a display panel device 350 to load the environmental data from the database 342 and display the loaded environmental data. When the server 340 detects that the environmental data exceeds a preset threshold, the server 340 generates a driving signal to drive a warning device 360, for example, the server 340 can drive the warning lamp to flash or light up a red light thereof. In addition, the server 340 can write the received environmental data into the register of the programmable logic controller 331 of the air conditioning device 330, in this way, a relay can be driven based on a control logic of the programmable logic controller 331 and the environmental parameter stored in the register, so as to control the air conditioning device 330 to activate or stop. For example, in a condition that the preset threshold is 35° C., and when the server 340 detects that the temperature in the environmental data exceeds 35° C. (for example, the temperature of the environmental data is 40° C.), the server 340 generates the driving signal to make the warning device 360 light up red light, and write the received environmental data into the register of the programmable logic controller 331. Therefore, in a condition that the control logic of the programmable logic controller 331 of the air conditioning device 330 is to automatically drive the relay to activate the air conditioning device 330 when the environmental data of the register exceeds a parameter threshold (such as 35° C.), the environmental abnormality in the area can be corrected. As a result, the operation of monitoring the environmental data and controlling feedback is completed.

As shown in FIG. 4, which is a schematic diagram of displaying charts on a display panel device, according to the application of the present invention. In actual implementation, as shown in FIG. 4, the display panel device 400 loads the environmental data from the database 342, and executes a visualization analysis on the loaded environmental data to generate a chart (such as, a temperature chart 420 or a humidity chart) containing the data variation, and display the generated chart on the display panel device 400, so as to facilitate an administrator to find the variation of the environmental data in real time. In addition, when each of the environmental data and the air conditioning device includes an area identifier, the environmental data can be displayed on a particular location based on the area identifier, such as the display block 410 shown in FIG. 4. In this way, the administrator can obtain the temperature distribution status in the production place in real time. In practice, the display panel device 400 can use a liquid crystal displayer, a plasma displayer or the like, to display the generated chart.

According to above-mentioned contents, the difference between the present invention and the conventional technology is that the first wireless transceiver module is electrically connected to environmental sensors to form the sensor module, the server is electrically connected to a second wireless transceiver module to form a network gateway, and the server can poll the sensor module to receive and store the environmental data through the network gateway, and permit the display panel device to load and display the stored environmental data in the chart; when the environmental data exceeds the preset threshold, the warning device is driven to write the received environmental data into the register of the programmable logic controller of the air conditioning device, so that the control logic can automatically control the air conditioning device to activate or stop based on the environmental data stored in the register. As a result, the technical solution of the present invention is able to solve the conventional technology problem and achieve the technical effect of improving the correction immediacy for environmental abnormality.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. An environmental data monitoring and feedback controlling system, comprising:
a plurality of environmental sensors configured to continuously sense environmental data;
a first wireless transceiver module electrically connected to the plurality of environmental sensors, to form a sensor module, and configured to transmit the environmental data;
a second wireless transceiver module configured to execute a wireless network transmission protocol the same as that of the first wireless transceiver module, to form a wireless network;
an air conditioning device comprising a programmable logic controller which comprises at least one register and is interconnected to a network; and
a server electrically connected to the network and the second wireless transceiver module to form a network gateway, and comprising:
a polling module configured to poll the sensor module to receive the environmental data through the network gateway in a wireless network;
a storage module connected to the polling module, and configured to store the received environmental data to a database, permit a display panel device to load the environmental data from the database to display the loaded environmental data; and
a control module connected to the storage module, and configured to generate a driving signal to drive a warning device, and write the environmental data into the at least one register of the programmable logic controller of the air conditioning device when the control module detects that the environmental data exceeds a preset threshold.

2. The environmental data monitoring and feedback controlling system according to claim 1, wherein the environmental sensor comprises a sensor for sensing at least one of temperature and humidity, and the environmental data includes at least one of data of temperature and humidity.

3. The environmental data monitoring and feedback controlling system according to claim 1, wherein after the display panel device loads the environmental data, the display panel device executes a visualization analysis on the loaded environmental data to generate and display a chart comprising data variation.

4. The environmental data monitoring and feedback controlling system according to claim 1, wherein each of the environmental data and the air conditioning device comprises an area identifier, and when the area identifier of the air conditioning device matches with the area identifier of the environmental data, the relay is driven to control the air conditioning device to start or stop.

5. The environmental data monitoring and feedback controlling system according to claim 1, wherein the warning device comprise at least one of a warning lamp, a speaker and a display, and when the driving signal is generated, an administrator is notified through at least one of email and instant messaging in a form of at least one of text, image and voice.

6. An environmental data monitoring and feedback controlling method, comprising:
providing a first wireless transceiver module which is electrically connected to a plurality of environmental sensors to form a sensor module, providing a server which is electrically connected to a network and a second wireless transceiver module to form a network gateway, wherein the first wireless transceiver module and the second wireless transceiver module execute the same wireless network transmission protocol to form a wireless network;
using the server to poll the sensor module to receive environmental data through the network gateway in the wireless network, and storing the environmental data to a database, permitting a display panel device to load the environmental data from the database, and displaying the loaded environmental data on the display panel device;
when the server detects that the environmental data exceeds a preset threshold, generating a driving signal to drive a warning device, and writing the received environmental data into the at least one register of the programmable logic controller of the air conditioning device, wherein the programmable logic controller is interconnected to the server through the network; and
using the air conditioning device to drive the relay based on a control logic of the programmable logic controller and the environmental parameter of the register, so as to control the air conditioning device to activate or stop.

7. The environmental data monitoring and feedback controlling method according to claim 6, wherein the environmental sensor comprises a sensor for sensing at least one of temperature and humidity, and the environmental data include at least one of data of temperature and humidity.

8. The environmental data monitoring and feedback controlling method according to claim 6, wherein after the display panel device loads the environmental data, the display panel device executes a visualization analysis on the loaded environmental data to generate and display a chart comprising data variation.

9. The environmental data monitoring and feedback controlling method according to claim 6, wherein each of the environmental data and the air conditioning device comprises an area identifier, and when the area identifier of the air conditioning device matches with the area identifier of the environmental data, the relay is driven to control the air conditioning device to activate or stop.

10. The environmental data monitoring and feedback controlling method according to claim 6, wherein the warning device comprise at least one of a warning lamp, a speaker and a display, and when the driving signal is generated, an administrator is notified through at least one of email and instant messaging in a form of at least one of text, image and voice.
